(19) United States
(12) Patent Application Publication
(10) Pub. No.: US 2017/0168273 A1
(43) Pub. Date: Jun. 15, 2017

(54) ZOOM LENS AND IMAGE PICKUP APPARATUS INCLUDING THE SAME

(71) Applicant: CANON KABUSHIKI KAISHA, Tokyo (JP)

(72) Inventor: Yoshinori Itoh, Yokohama-shi (JP)

(21) Appl. No.: 15/370,962

(22) Filed: Dec. 6, 2016

(30) Foreign Application Priority Data
Dec. 14, 2015 (JP) 2015-242953

(51) Int. Cl. G02B 15/173; G02B 15/20; G02B 5/00

(52) U.S. Cl. CPC G02B 15/173; G02B 5/005; G02B 15/20

(57) ABSTRACT

A zoom lens includes a first lens unit having a positive refractive power, a second lens unit having a negative refractive power, a third lens unit having a positive refractive power, a fourth lens unit having a positive refractive power, and a fifth lens unit having a negative refractive power, and the first through fifth lens units are disposed in order from an object side to an image side. When zooming, a distance between adjacent lens units changes. The first lens unit includes a reflective member having a reflective surface configured to bend an optical path. The third lens unit includes an aperture stop. When zooming, the third lens unit moves such that the third lens unit is located closer to the image side at a telephoto end than at a wide angle end.

### BACKGROUND OF THE INVENTION

Field of Invention

The present invention relates to a zoom lens and an image pickup apparatus including the zoom lens. The zoom lens is considered suitable for, for example, a video camera, a digital still camera, a monitoring camera, a silver-halide photography camera, a broadcasting camera, a smartphone, a tablet, a wearable device imaging device, and the like.

Description of Related Art

In recent years, an image pickup optical system for use in an image pickup apparatus is required to be a zoom lens that has a high zoom ratio, that is small in size as a whole, and that, when used in an image pickup apparatus, can reduce the thickness (the thickness in the depthwise direction) of the image pickup apparatus. To that end, a bending-type zoom lens is known in which a reflective member that bends an optical axis (optical path) of an image pickup optical system by 90 degrees, such as a prism member that uses inner surface reflection, is disposed in the optical path in order to reduce the thickness of an image pickup apparatus.

U.S. Pat. No. 7,907,350 and Japanese Patent Application Laid-Open No. 2011-17773 disclose a five-unit zoom lens constituted of first through fifth lens units having positive, negative, positive, positive, and negative refractive powers, respectively, disposed in this order from the object side to the image side, and a reflective member for bending an optical path is disposed in the first lens unit in the zoom lens.

Typically, with a zoom lens in which a reflective member (reflective optical element) for bending an optical path is disposed between lens units, the thickness of an image pickup apparatus can be reduced with ease by disposing lens units in the thickness direction of the image pickup apparatus and in a direction orthogonal to the thickness direction.

In order to obtain high optical performance throughout the zoom range at a high zoom ratio while keeping the size of the entire system small with the use of a reflective member, it is important to set the configuration of the zoom lens appropriately. For example, it is important to appropriately set the zoom type, the arrangement of the reflective member, the position of an aperture stop, the amount of movement of the lens units that move when zooming, and other such parameters related to achieving a high zoom ratio while maintaining the overall size small. In particular, for example, if the moving condition of the aperture stop when zooming is inappropriate, the effective diameter of a first lens unit increases, and it becomes difficult to keep the size of the entire system small.

### SUMMARY OF THE INVENTION

According to the various embodiments of the present invention a zoom lens includes a first lens unit having a positive refractive power, a second lens unit having a negative refractive power, a third lens unit having a positive refractive power, a fourth lens unit having a positive refractive power, and a fifth lens unit having a negative refractive power, and the first through fifth lens units are disposed in order from an object side to an image side. When zooming, a distance between adjacent lens units changes. The first lens unit includes a reflective member having a reflective surface configured to bend an optical path. The third lens unit includes an aperture stop. When zooming, the third lens unit moves such that the third lens unit is located closer to the image side at a telephoto end than at a wide angle end.

Further features of the present invention will become apparent from the following description of exemplary embodiments with reference to the attached drawings.

### BRIEF DESCRIPTION OF THE DRAWINGS

FIGS. 1A, 1B, and 1C are lens sectional views of a zoom lens at a wide angle end, an intermediate zoom position, and a telephoto end, respectively, according to a first exemplary embodiment of the present invention.

FIGS. 2A, 2B, and 2C are aberration diagrams of the zoom lens at the wide angle end, the intermediate zoom position, and the telephoto end, respectively, according to a first exemplary embodiment.

FIGS. 3A, 3B, and 3C are lens sectional views of a zoom lens at a wide angle end, an intermediate zoom position, and a telephoto end, respectively, according to a second exemplary embodiment of the present invention.

FIGS. 4A, 4B, and 4C are aberration diagrams of the zoom lens at the wide angle end, the intermediate zoom position, and the telephoto end, respectively, according to the second exemplary embodiment.

FIGS. 5A, 5B, and 5C are lens sectional views of a zoom lens at a wide angle end, an intermediate zoom position, and a telephoto end, respectively, according to a third exemplary embodiment of the present invention.

FIGS. 6A, 6B, and 6C are aberration diagrams of the zoom lens at the wide angle end, the intermediate zoom position, and the telephoto end, respectively, according to the third exemplary embodiment.

FIGS. 7A, 7B, and 7C are lens sectional views of a zoom lens at a wide angle end, an intermediate zoom position, and a telephoto end, respectively, according to a fourth exemplary embodiment of the present invention.

FIGS. 8A, 8B, and 8C are aberration diagrams of the zoom lens at the wide angle end, the intermediate zoom position, and the telephoto end, respectively, according to the fourth exemplary embodiment.

FIGS. 9A and 9B are lens sectional views of the zoom lens at the wide angle end and the telephoto end, respectively, according to the first exemplary embodiment.

FIG. 10 is a schematic diagram of relevant portions of an image pickup apparatus according to an exemplary embodiment of the present invention.

### DESCRIPTION OF THE EMBODIMENTS

Hereinafter, a zoom lens and an image pickup apparatus including the zoom lens according to exemplary embodiments of the present invention will be described. A zoom lens according to an exemplary embodiment of the present invention includes a first lens unit having a positive refractive power, a second lens unit having a negative refractive power, a third lens unit having a positive refractive power, a fourth lens unit having a positive refractive power, and a fifth lens unit having a negative refractive power, and the first through fifth lens units are disposed in order from an object side to an image side. When zooming, the distance between adjacent lens units changes.

The first lens unit includes a reflective member having a reflective surface configured to bend an optical path. The third lens unit includes an aperture stop. When zooming, the third lens unit moves such that the third lens unit is located closer to the image side at a telephoto end than at a wide angle end.

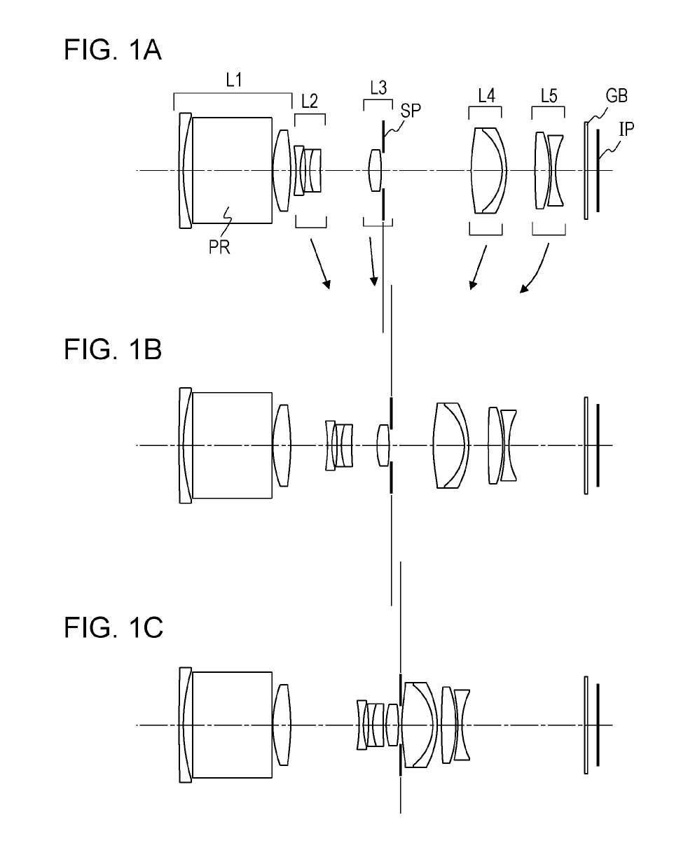

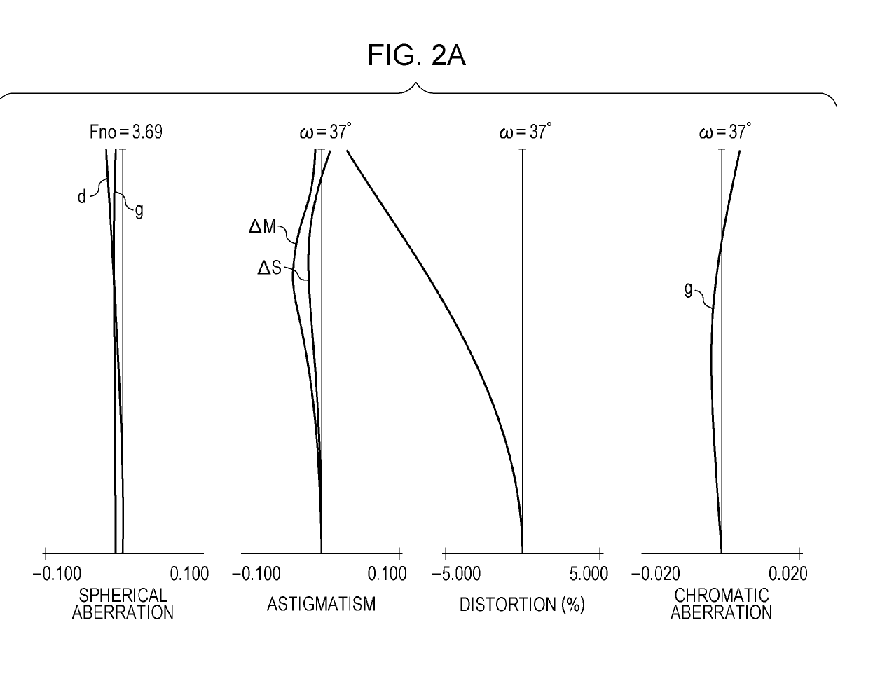

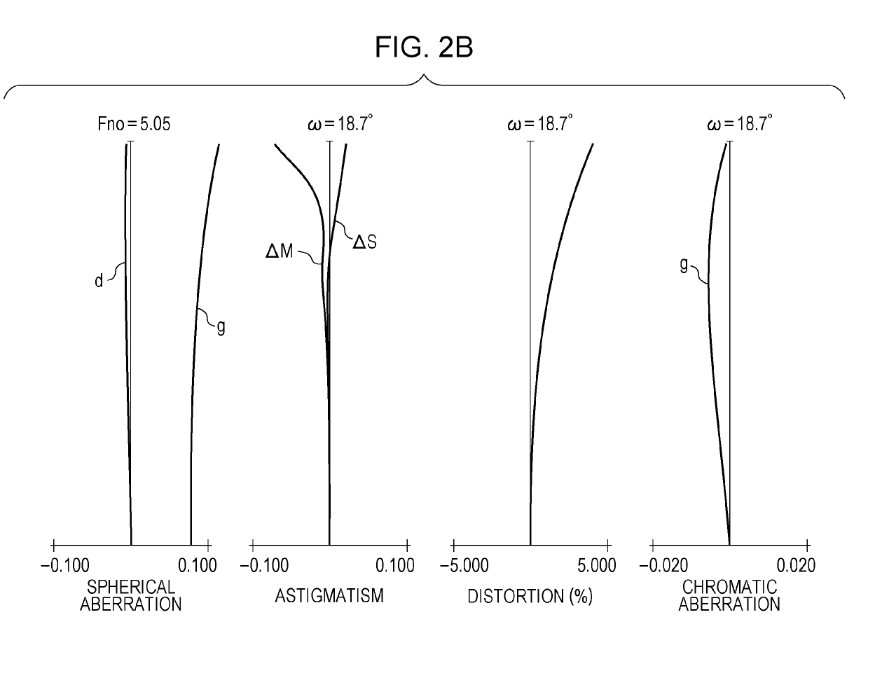

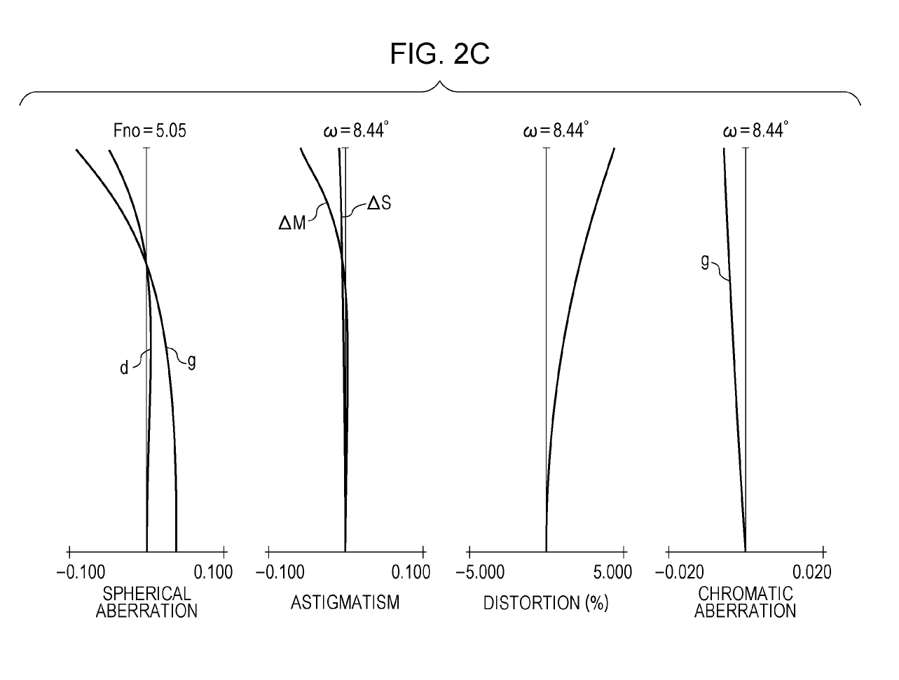

FIGS. 1A, 1B, and 1C are lens sectional views of a zoom lens according to a first exemplary embodiment of the present invention at the wide angle end (short focal length end), an intermediate zoom position, and the telephoto end (long focal length end), respectively. FIGS. 2A, 2B, and 2C are aberration diagrams of the zoom lens according to the first exemplary embodiment at the wide angle end, the intermediate zoom position, and the telephoto end, respectively. The first exemplary embodiment provides a zoom lens having a zoom ratio of 4.73 and an F-number of 3.69 to 5.05.

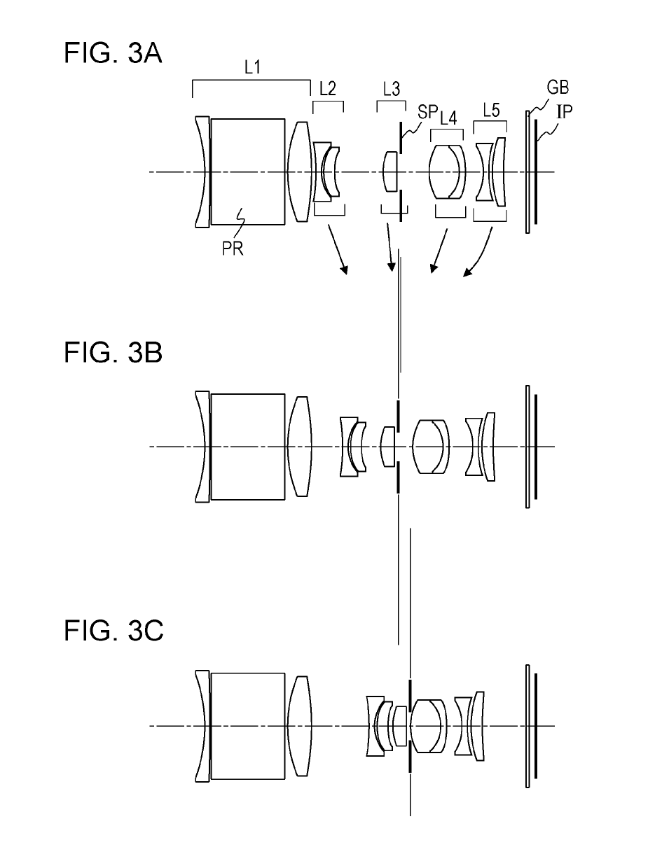

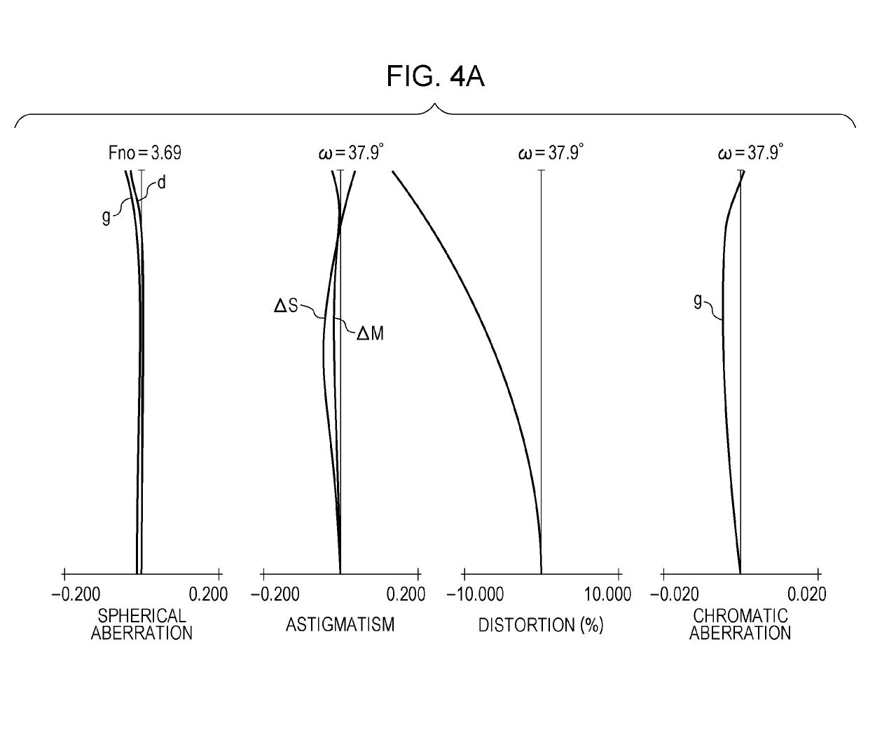

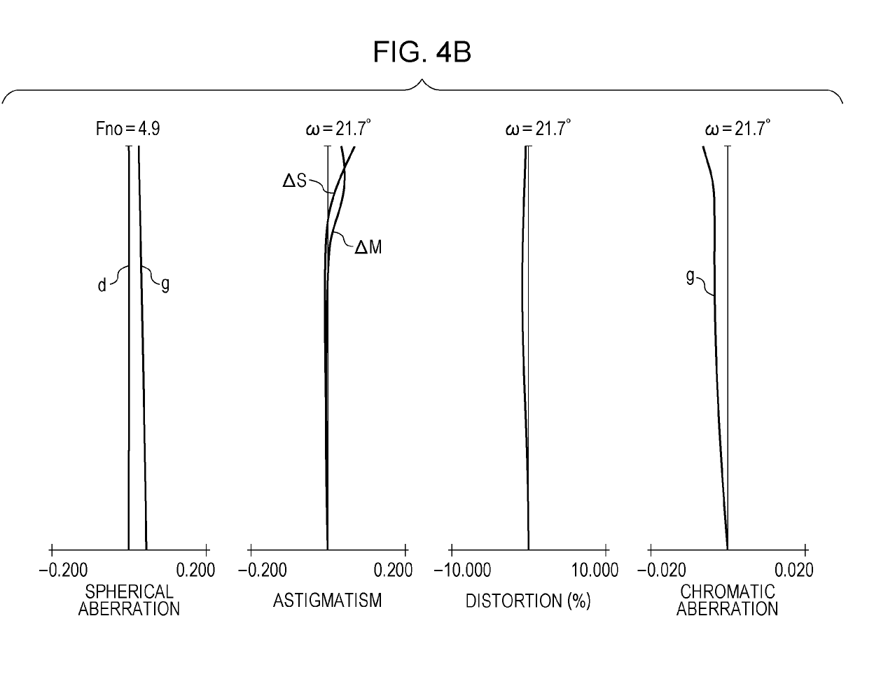

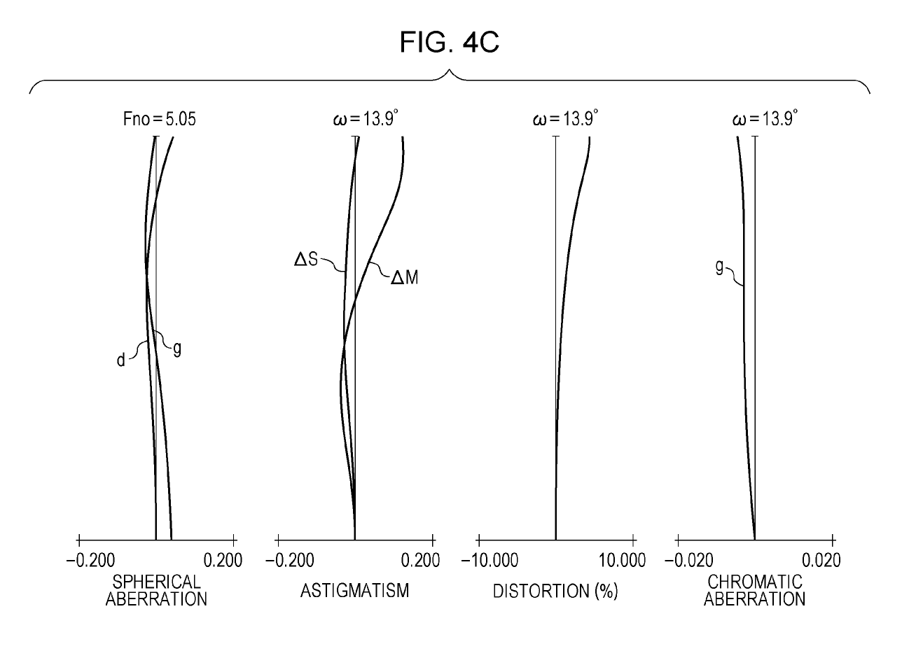

FIGS. 3A, 3B, and 3C are lens sectional views of a zoom lens according to a second exemplary embodiment of the present invention at the wide angle end, the intermediate zoom position, and the telephoto end, respectively. FIGS. 4A, 4B, and 4C are aberration diagrams of the zoom lens according to the second exemplary embodiment at the wide angle end, the intermediate zoom position, and the telephoto end, respectively. The second exemplary embodiment provides a zoom lens having a zoom ratio of 2.84 and an F-number of 3.69 to 5.05.

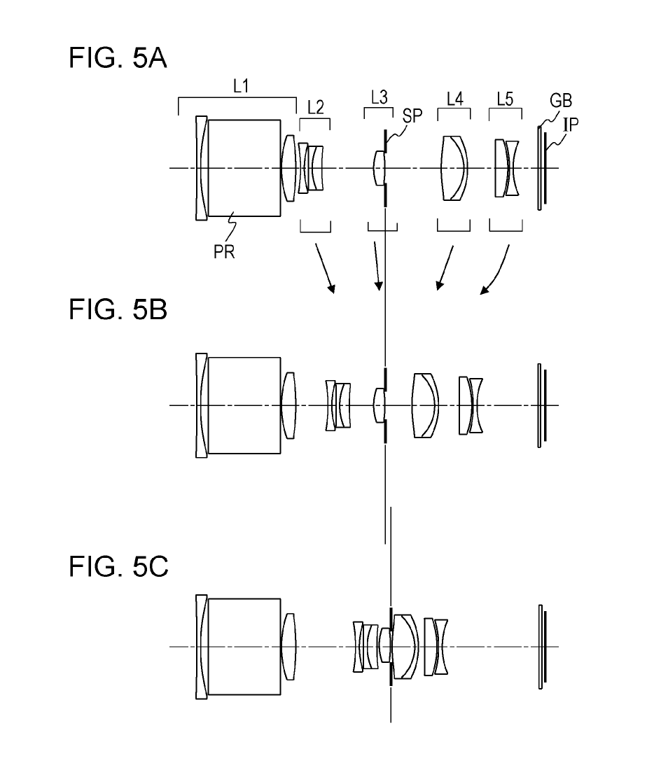

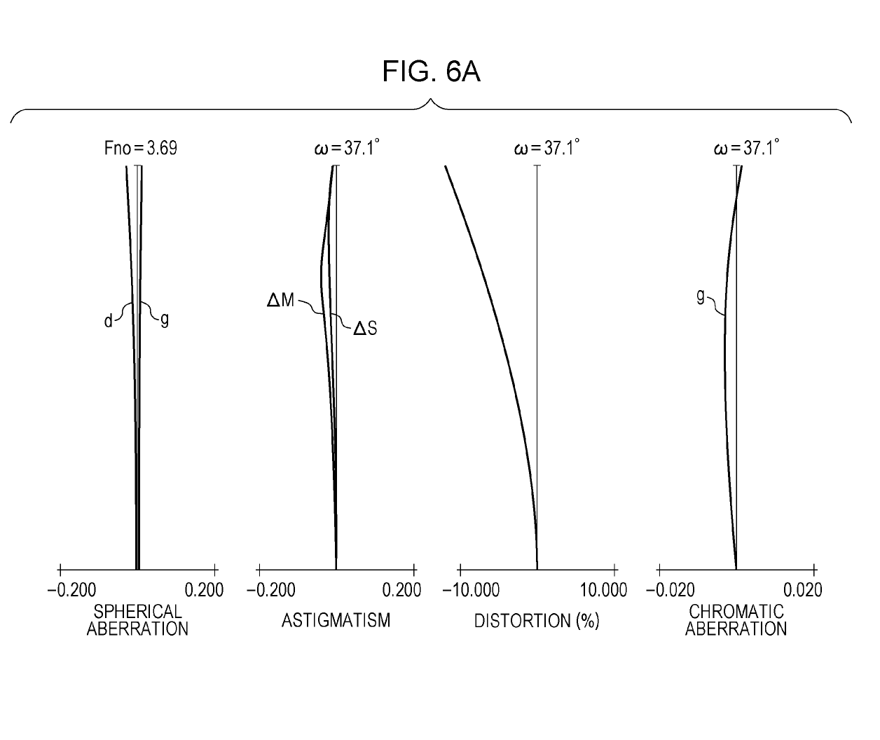

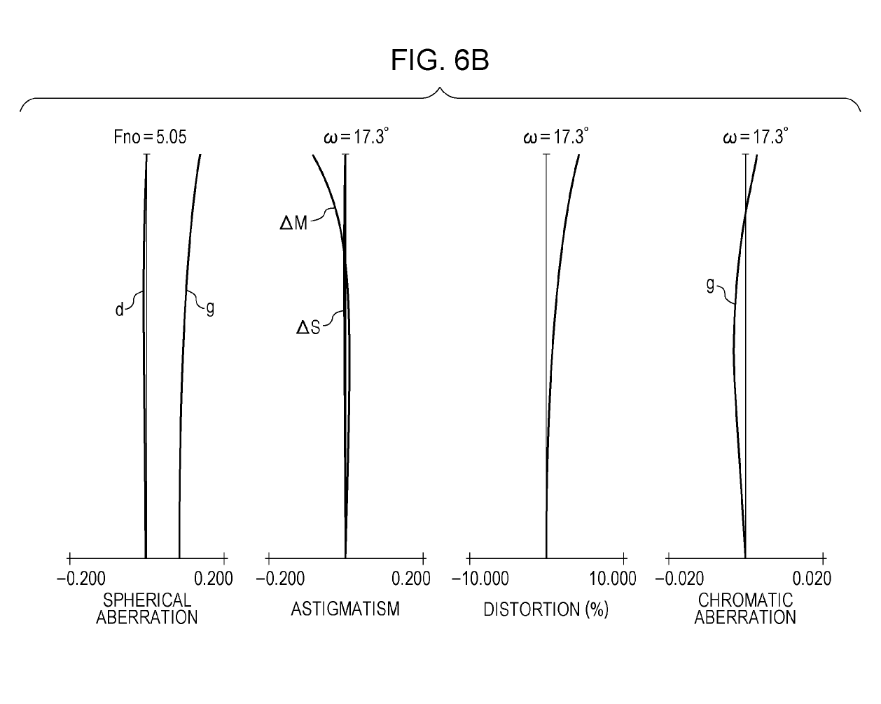

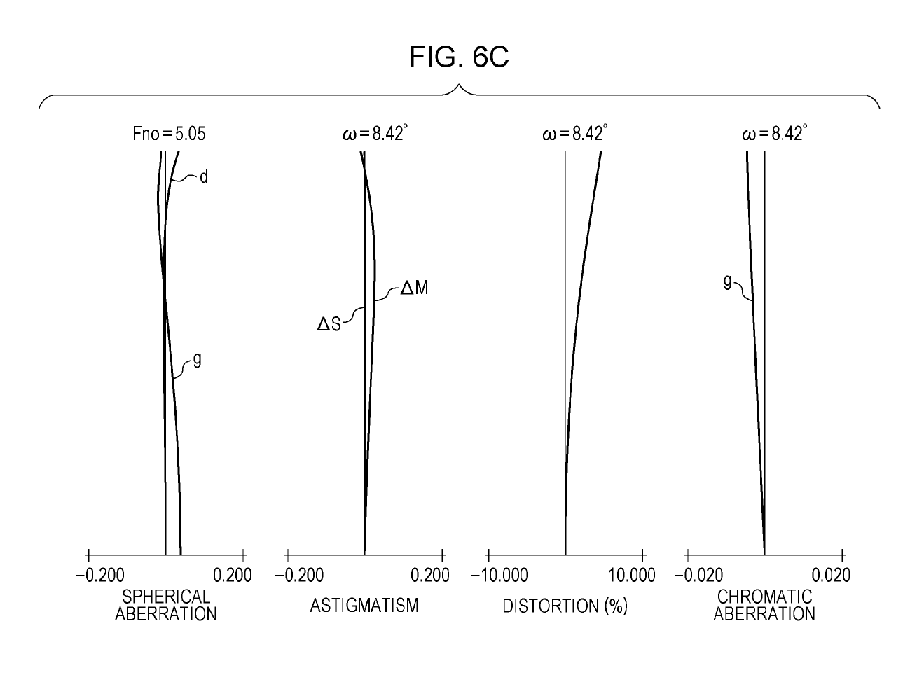

FIGS. 5A, 5B, and 5C are lens sectional views of a zoom lens according to a third exemplary embodiment of the present invention at the wide angle end, the intermediate zoom position, and the telephoto end, respectively. FIGS. 6A, 6B, and 6C are aberration diagrams of the zoom lens according to the third exemplary embodiment at the wide angle end, the intermediate zoom position, and the telephoto end, respectively. The third exemplary embodiment provides a zoom lens having a zoom ratio of 4.73 and an F-number of 3.69 to 5.05.

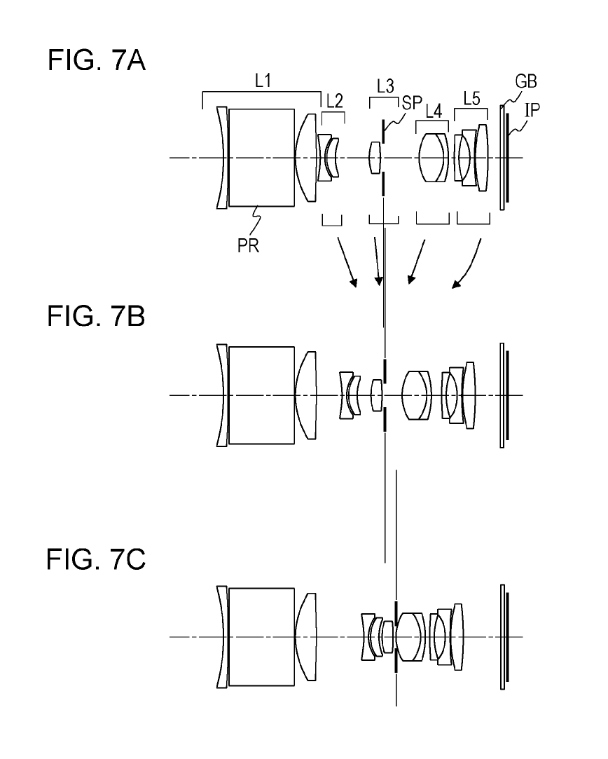

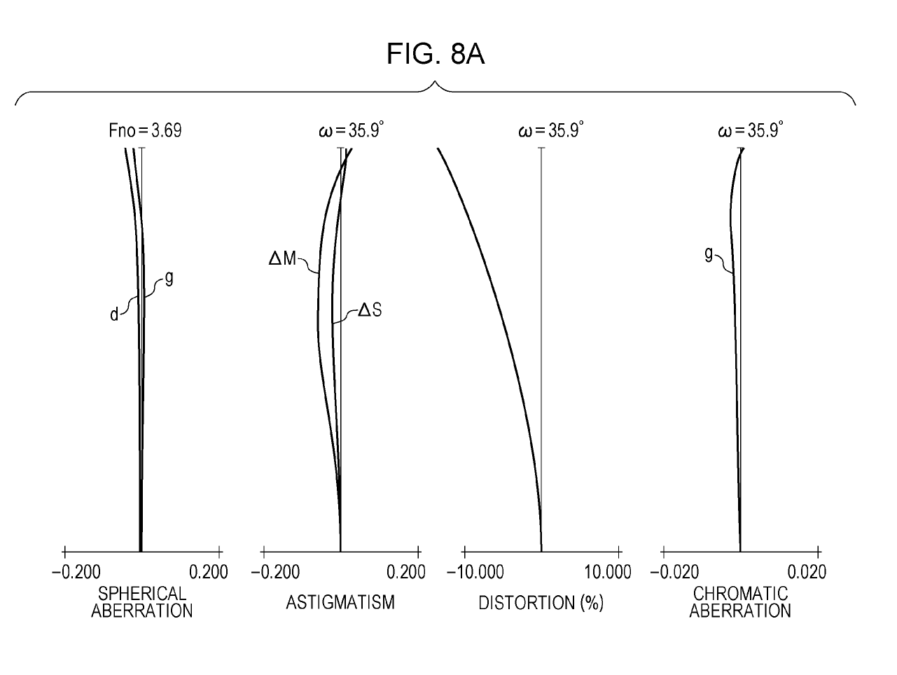

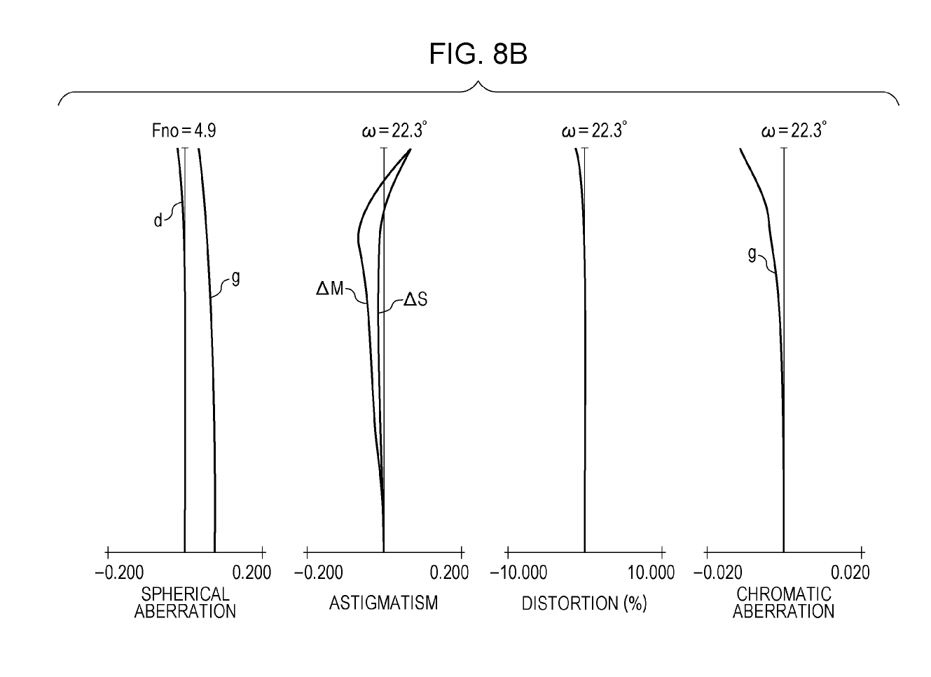

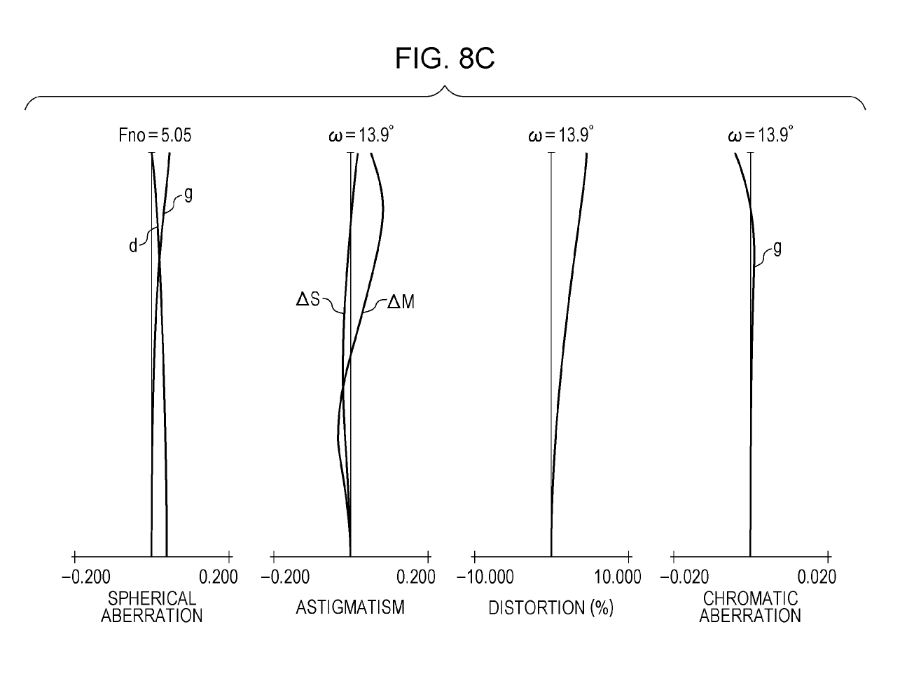

FIGS. 7A, 7B, and 7C are lens sectional views of a zoom lens according to a fourth exemplary embodiment of the present invention at the wide angle end, the intermediate zoom position, and the telephoto end, respectively. FIGS. 8A, 8B, and 8C are aberration diagrams of the zoom lens according to the fourth exemplary embodiment at the wide angle end, the intermediate zoom position, and the telephoto end, respectively. The fourth exemplary embodiment provides a zoom lens having a zoom ratio of 2.84 and an F-number of 3.69 to 5.05.

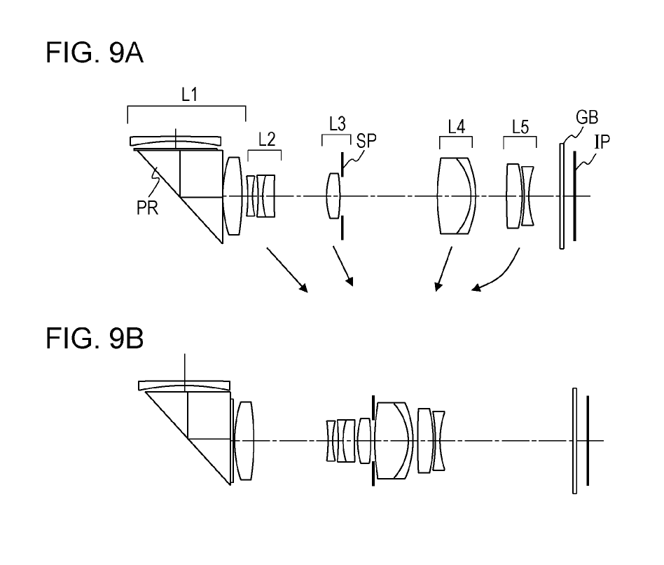

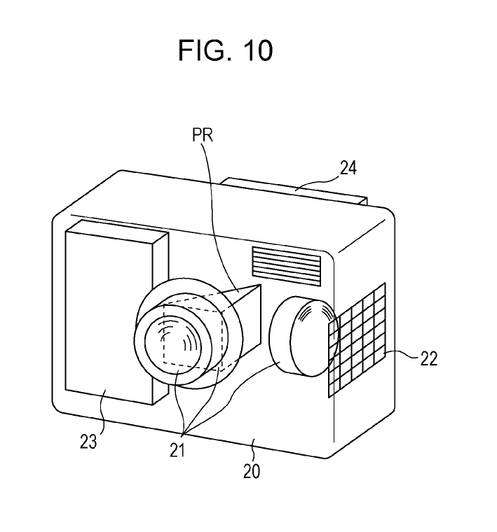

Although the optical path is bent by a reflective member (prism member) having a reflective surface provided within a prism in the lens sectional view according to each of the exemplary embodiments, each of the lens sectional views illustrates the optical path in a developed manner for convenience. FIGS. 9A and 9B are lens sectional views of the zoom lens according to the first exemplary embodiment in a state in which the optical path is bent by the reflective member at the wide angle end and the telephoto end. FIG. 10 is a schematic diagram of a primary portion of a camera (image pickup apparatus) including a zoom lens according to an exemplary embodiment of the present invention.

The zoom lens according to each of the exemplary embodiments is an image pickup lens system to be used in an image pickup apparatus, such as a video camera, a digital camera, and a silver-halide film camera. In the lens sectional view, the left side corresponds to the side of an object (object side) (front side), and the right side corresponds to the image side (back side). In the lens sectional view, i indicates the order of the lens unit counted from the object side, and Li represents an ith lens unit.

The reference character SP denotes an aperture stop that restricts an F-number luminous flux. The reference character PR denotes a reflective member for bending an optical path, and the reflective member PR includes a reflective surface in each of the exemplary embodiments and is constituted by a prism (a material of the prism can be a glass material or a plastic material) that bends the optical path by 90 degrees or about 90 degrees (90 degrees ±10 degrees). The reference character GB denotes an optical block corresponding to an optical filter, a face plate, a crystal low pass filter, an infrared cut-off filter, or the like, or a combination of one or more of such optical elements.

The reference character IP denotes an image plane. An image pickup surface of a solid-state image pickup element (photoelectric conversion element), such as a charge-coupled device (CCD) sensor or a complementary metal-oxide semiconductor (CMOS) sensor, is placed at the image plane IP when the zoom lens is used as an image pickup optical system in a video camera or a digital still camera, or a photosensitive surface corresponding to a film surface is placed at the image plane IP when the zoom lens is used in a silver-halide film camera. The arrows indicate the movement loci of the lens units and of the aperture stop SP when zooming from the wide angle end to the telephoto end. In the lens sectional view, y corresponds to the direction of the short side of the image pickup element.

Of the aberration diagrams, in the spherical aberration diagrams, d represents aberration with respect to the Fraunhofer d-line, and g represents aberration with respect to the Fraunhofer g-line. In the astigmatism diagrams, ΔM represents a meridional image plane, and ΔS represents a sagittal image plane. In the chromatic aberration of magnification, g represents the g-line, ω represents a half angle of view (a value representing a half of the shooting angle of view) (degree), and Fno represents the F-number. It is noted that, in each of the following exemplary embodiments, the wide angle end and the telephoto end refer to opposite end positions held by lens units when moved for varying the magnification are located at respective ends of a range within which the lens units can move mechanically along the optical axis.

The zoom type of the zoom lens according to each of the exemplary embodiments is as follows. The zoom lens includes a first lens unit L1 having a positive refractive power, a second lens unit L2 having a negative refractive power, a third lens unit L3 having a positive refractive power, a fourth lens unit L4 having a positive refractive power, and a fifth lens unit L5 having a negative refractive power, and the first through fifth lens units L1 through L5 are disposed in order from the object side to the image side. The third lens unit L3 includes the aperture stop SP.

When zooming from the wide angle end to the telephoto end, the second lens unit L2 moves toward the image side. The third lens unit L3 moves monotonically toward the image side or moves toward the object side and then moves toward the image side when zooming from the wide angle end to the telephoto end so that the third lens unit L3 is located closer to the image side at the telephoto end than at the wide angle end. When zooming from the wide angle end to the telephoto end, the fourth lens unit L4 and the fifth lens unit L5 move toward the object side. When zooming, the first lens unit L1 is stationary. When zooming, the distance between adjacent lens units changes. When focusing from infinity to a close range, the fifth lens unit L5 moves toward the image side.

In each of the exemplary embodiments, the first lens unit L1 is constituted by a negative lens, a reflective member PR including a reflective surface configured to bend an optical path (optical path bending unit), and a positive lens that are disposed in order from the object side to the image side. It is to be noted that the reflective member is not limited to a prism member and may instead be a mirror. In order to obtain a high zoom ratio and, when the zoom lens is applied to a camera, reduce the dimension of the camera in the thickness direction thereof, it is desirable that the effective diameter of the first lens unit L1 having the reflective member PR for bending the optical path be reduced and that the size of the reflective member PR be reduced by reducing the optical path length of the reflective member PR.

In the zoom lens having the reflective member PR, the dimension of the camera in the vertical direction is substantially determined by the size of the reflective member PR disposed in the first lens unit L1. Therefore, it is desirable to use a positive lead type zoom lens in which the first lens unit L1 is stationary when zooming and an increase in the effective diameter of the first lens unit L1 can be suppressed with ease.

In the zoom lens according to an exemplary embodiment of the present invention, when the aperture stop SP is disposed on the object side of the third lens unit L3 and the third lens unit L3 is made stationary when zooming, the aperture stop SP has to be spaced apart from the first lens unit L1 by the amount of the zoom stroke of the second lens unit L2. Consequently, the size of the reflective member PR provided in the first lens unit L1 tends to increase.

In the zoom lens according to an exemplary embodiment of the present invention, the third lens unit L3 includes the aperture stop SP, and the third lens unit L3 moves such that the third lens unit L3 is located closer to the image side at the telephoto end than at the wide angle end when zooming. With this configuration, the position of the entrance pupil can be made closer to the first lens unit L1 at the wide angle end and in the zoom range of the wide angle side, and the size of the first lens unit L1 and the effective diameter of the reflective member PR are reduced.

In each of the exemplary embodiments, in order to reduce the thickness of the camera when the zoom lens is applied to the camera while keeping the size of the entire system small, it is desirable that one or more of the following conditional expressions be satisfied. The amount of movement of the third lens unit L3 when zooming from the wide angle end to the telephoto end is represented by M3, and the focal length of the entire system at the wide angle end is represented by fw. The focal length of the third lens unit L3 is represented by f3, the focal length of the fifth lens unit L5 is represented by f5, and the focal length of the entire system at the telephoto end is represented by ft. The amount of movement of the fifth lens unit L5 when zooming from the wide angle end to the telephoto end is represented by M5.

Here, the amount of movement of a lens unit when zooming from the wide angle end to the telephoto end refers to a difference in the position of the lens unit in the optical axis direction between the wide angle end and the telephoto end. The sign of the amount of movement is negative when the lens unit is located closer to the object side at the telephoto end than at the wide angle end and is positive when the lens unit is located closer to the image side at the telephoto end than at the wide angle end.

At this point, it is desirable that one or more of the following conditional expressions be satisfied.

0.05<M3/fw<0.80 (1)

0.2<f3/ft<0.7 (2)

−1.4<f3/f5<−0.4 (3)

0.2<|M5|/fw<3.0 (4)

Next, the technical meaning of each of the conditional expressions above will be described. The conditional expression (1) is for appropriately setting the amount of movement of the third lens unit L3 when zooming and for preventing the third lens unit L3 from interfering with the fourth lens unit L4 in the telephoto range while keeping the size of the entire system small. In addition, the focal length of the third lens unit L3 is set appropriately by satisfying the conditional expression (2), making it easier to increase the zoom ratio.

The fifth lens unit L5, which is disposed closest to the image side in the zoom lens according to an exemplary embodiment of the present invention, is a telephoto type as a whole and has a negative refractive power that satisfies the conditional expression (3) in order to reduce the total lens length. In addition, as the fifth lens unit L5 is moved toward the object side so as to satisfy the conditional expression (4) when zooming from the wide angle end to the telephoto end, the fifth lens unit L5 contributes to varying the magnification.

As the fifth lens unit L5 bears a predetermined magnification varying burden, the magnification varying burdens of the second lens unit L2 and of the fourth lens unit L4 are reduced. Thus, the zoom strokes of the second lens unit L2 and of the fourth lens unit L4 are reduced, and the total lens length is reduced. In addition, as the conditional expressions (2), (3), and (4) are satisfied, the magnification varying burdens of the second lens unit L2, of the fourth lens unit L4, and of the fifth lens unit L5 are distributed, and the zoom strokes are reduced.

In order to ensure the zoom ratio of 2.84 to 4.73, the magnification varying burden is distributed among the second lens unit L2, the fourth lens unit L4, and the fifth lens unit L5. With this configuration, the stroke of each lens unit is reduced, and the size of the lens system toward the image side of the reflective member PR is reduced.

In the wide angle range in which the imaging angle of view increases, the third lens unit L3 is disposed at a position close to the first lens unit L1. Thus, the size of the first lens unit L1 is reduced, and the optical path length of the reflective member PR is reduced.

The effective range of the image pickup element typically has a rectangular shape of 4:3, 3:2, 16:9, or the like. The effective portion in the direction of the long side differs from the effective portion in the direction of the short side. Therefore, the optical path is bent in the direction of the short side having a smaller effective portion in the zoom lens according to an exemplary embodiment of the present invention, and thus the size of the reflective member PR is reduced.

In the conditional expression (1), the amount of movement of the third lens unit L3 when zooming is normalized by the focal length of the entire system at the wide angle end. As the conditional expression (1) is satisfied, the position of the third lens unit L3 on the optical axis at the wide angle end is disposed at a position close to the first lens unit L1, and thus the effective diameter of the first lens unit L1 is reduced.

When the amount of movement of the third lens unit L3 becomes too large such that the ratio exceeds the upper limit value of the conditional expression (1), the third lens unit L3 is more likely to interfere with the fourth lens unit L4 that moves toward the object side at the telephoto end. Then, it becomes difficult to obtain a sufficient magnification varying burden with the fourth lens unit L4, and it becomes difficult to obtain a desired zoom ratio. When a predetermined zoom ratio is to be obtained, the size of the lens system toward the image side of the reflective member PR increases. When the amount of movement of the third lens unit L3 becomes too small such that the ratio falls below the lower limit value of the conditional expression (1), the distance between the first lens unit L1 and the aperture stop SP becomes too large in the wide angle range, and the effective diameter of the first lens unit L1 thus becomes too large, which is not desirable.

In the conditional expression (2), the focal length of the third lens unit L3 is normalized by the focal length of the entire system at the telephoto end. When the focal length of the third lens unit L3 becomes too large such that the ratio exceeds the upper limit value of the conditional expression (2), the action of converging the divergent light from the second lens unit L2 is reduced, and the lens diameter of the fourth lens unit L4 increases, which is not desirable. When the focal length of the third lens unit L3 becomes too small such that the ratio falls below the lower limit value of the conditional expression (2), the coma flare at the peripheral portion of the screen increases in the zoom range of the wide angle range, and it becomes difficult to correct this coma flare.

In the conditional expression (3), the focal length of the third lens unit L3 is normalized by the focal length of the fifth lens unit L5. When the negative focal length of the fifth lens unit L5 becomes too large (when the absolute value of the negative focal length becomes too large) such that the ratio exceeds the upper limit value of the conditional expression (3), the magnification varying burden borne by the fifth lens unit L5 is reduced, and the telephoto ratio increases. Furthermore, the size of the lens system toward the image side of the reflective member PR increases.

When the negative focal length of the fifth lens unit L5 becomes too small (when the absolute value of the negative focal length becomes too small) such that the ratio falls below the lower limit value of the conditional expression (3), the exit pupil becomes short at the wide angle end, the angle of incidence of the light beam at the marginal angle of view onto the image pickup element increases, and shading increases, which is not desirable.

In the conditional expression (4), the amount of movement of the fifth lens unit L5 when zooming is normalized by the focal length of the entire system at the wide angle end. As the conditional expression (4) is satisfied, the fifth lens unit L5 bears an appropriate magnification varying burden, and the magnification varying burdens of the second lens unit L2 and of the fourth lens unit L4 are reduced. When the amount of movement of the fifth lens unit L5 becomes too large such that the ratio exceeds the upper limit value of the conditional expression (4), it becomes difficult to ensure the back focus of a predetermined length at the wide angle end.

When the amount of movement of the fifth lens unit L5 becomes too small such that the ratio falls below the lower limit value of the conditional expression (4), the magnification varying burdens of the second lens unit L2 and of the fourth lens unit L4 increase, and the total lens length increases due to an increase in the stroke when zooming, which is not desirable.

It is more preferable that the numerical ranges of the conditional expressions (1) through (4) be set as follows.

0.08<M3/fw<0.40 (1a)

0.3<f3/ft<0.5 (2a)

−1.3<f3/f5<−0.6 (3a)

0.25<|M5|/fw<2.00 (4a)

It is to be noted that the focusing may be achieved with any of the first lens unit L1, the third lens unit L3, and the fourth lens unit L4. In addition, the focusing may be achieved by moving the image pickup element.

Next, the lens configuration in each of the exemplary embodiments will be described. Hereinafter, it is assumed that the lenses included in each of the lens units are disposed in order from the object side to the image side.

### First Exemplary Embodiment

When the zoom lens is at the telephoto end zoom position (e.g., FIG. 1C), as compared to at the wide angle end zoom position (e.g., FIG. 1A), the distance between the first lens unit L1 and the second lens unit L2 is larger, the distance between the second lens unit L2 and the third lens unit L3 is smaller, the distance between the third lens unit L3 and the fourth lens unit L4 is smaller, and the distance between the fourth lens unit L4 and the fifth lens unit L5 is smaller.

The first lens unit L1 is constituted by a negative lens whose surface on the image side has a concave shape, a reflective member PR, and a positive lens having a biconvex shape. The second lens unit L2 is constituted by a negative lens having a biconcave shape, a negative lens having a biconcave shape, and a positive lens. The third lens unit L3 is constituted by a positive lens having a biconvex shape. The third lens unit L3 includes an aperture stop SP on the image side of the positive lens. The fourth lens unit L4 is constituted by a cemented lens in which a positive lens having a biconvex shape and a negative lens having a meniscus shape convex toward the image side are cemented. The fifth lens unit L5 is constituted by a positive lens having a biconvex shape and a negative lens having a biconcave shape.

### Second Exemplary Embodiment

At the telephoto end than at the wide angle end, the lens unit distance between the first lens unit L1 and the second lens unit L2 is larger, the lens unit distance between the second lens unit L2 and the third lens unit L3 is smaller, the lens unit distance between the third lens unit L3 and the fourth lens unit L4 is smaller, and the lens unit distance between the fourth lens unit L4 and the fifth lens unit L5 is smaller. However, the lens unit distance between the fourth lens unit L4 and the fifth lens unit L5 increases and then decreases when zooming from the wide angle end to the telephoto end.

The first lens unit L1 is constituted by a negative lens whose surface on the object side has a concave shape, a reflective member PR, and a positive lens having a biconvex shape. The second lens unit L2 is constituted by a negative lens having a biconcave shape and a positive lens. The third lens unit L3 is constituted by a positive lens. The third lens unit L3 includes an aperture stop SP on the image side. The fourth lens unit L4 is constituted by a cemented lens in which a positive lens having a biconvex shape and a negative lens having a meniscus shape convex toward the image side are cemented. The fifth lens unit L5 is constituted by a negative lens and a positive lens.

### Third Exemplary Embodiment

At the telephoto end than at the wide angle end, the lens unit distance between the first lens unit L1 and the second lens unit L2 is larger, the lens unit distance between the second lens unit L2 and the third lens unit L3 is smaller, the lens unit distance between the third lens unit L3 and the fourth lens unit L4 is smaller, and the lens unit distance between the fourth lens unit L4 and the fifth lens unit L5 is smaller.

The first lens unit L1 is constituted by a negative lens having a biconcave shape, a reflective member PR, and a positive lens having a biconvex shape. The second lens unit L2 is constituted by a negative lens having a biconcave shape, a negative lens having a biconcave shape, and a positive lens. The third lens unit L3 is constituted by a positive lens having a biconvex shape. The third lens unit L3 includes an aperture stop SP on the image side. The fourth lens unit L4 is constituted by a cemented lens in which a positive lens having a biconvex shape and a negative lens having a meniscus shape convex toward the image side are cemented. The fifth lens unit L5 is constituted by a positive lens and a negative lens having a biconcave shape.

### Fourth Exemplary Embodiment

At the telephoto end than at the wide angle end, the lens unit distance between the first lens unit L1 and the second lens unit L2 is larger, the lens unit distance between the second lens unit L2 and the third lens unit L3 is smaller, the lens unit distance between the third lens unit L3 and the fourth lens unit L4 is smaller, and the lens unit distance between the fourth lens unit L4 and the fifth lens unit L5 is smaller. However, the lens unit distance between the fourth lens unit L4 and the fifth lens unit L5 increases and then decreases when zooming from the wide angle end to the telephoto end.

The first lens unit L1 is constituted by a negative lens whose surface on the object side has a concave shape, a reflective member PR, and a positive lens having a biconvex shape. The second lens unit L2 is constituted by a negative lens having a biconcave shape and a positive lens. The third lens unit L3 is constituted by a positive lens having a biconvex shape. The third lens unit L3 includes an aperture stop SP on the image side. The fourth lens unit L4 is constituted by a cemented lens in which a positive lens having a biconvex shape and a negative lens having a meniscus shape convex toward the image side are cemented. The fifth lens unit L5 is constituted by a positive lens, a negative lens, and a positive lens.

FIGS. 9A and 9B illustrate a state in which the optical path is bent by 90 degrees by the reflective member PR at the wide angle end and the telephoto end of the zoom lens according to the first exemplary embodiment illustrated in FIGS. 1A through 1C, and the reference characters appended to the components, the movement when zooming, and so on are the same as those of FIGS. 1A through 1C.

Next, an exemplary embodiment of a digital still camera in which a zoom lens such as the one illustrated in each of the exemplary embodiments is used as an image pickup optical system will be described with reference to FIG. 10. Illustrated in FIG. 10 are a camera main body 20 and an image pickup optical system 21 that is constituted by the zoom lens described in any one of the first through fourth exemplary embodiments.

The reference character PR denotes a reflective member for bending an optical path. A solid-state image pickup element (photoelectric conversion element) 22 is embedded in the camera main body and is constituted by a CCD sensor, a CMOS sensor, or the like that receives an object image formed by the image pickup optical system 21. A memory 23 records information corresponding to the object image that has been subjected to photoelectric conversion by the solid-state image pickup element 22. A finder 24 is constituted by a liquid-crystal display panel or the like and is used to observe the object image formed on the solid-state image pickup element 22. In this manner, by applying the zoom lens according to an exemplary embodiment of the present invention to an image pickup apparatus, such as a digital still camera, an image pickup apparatus that is small in size and that has high optical performance is achieved.

Next, first through fourth numerical data corresponding, respectively, to the first through fourth exemplary embodiments of the present invention will be illustrated. In each of the numerical data, i represents the order of a given optical surface counted from the object side. In addition, ri represents the radius of curvature of an ith optical surface (ith surface), di represents the distance between an ith surface and an (i+1)th surface, ndi and νdi represent the refractive index and the Abbe number, respectively, of the material for an ith optical member with respect to the d-line.

Furthermore, aspheric surface is denoted by an asterisk (*) next to the surface number. In the aspherical surface data, k represents the eccentricity, A4, A6, A8, and A10 represent the aspherical coefficients, and the displacement in the optical axis direction at the position of a height h from the optical axis is represented by x with the surface vertex serving as a reference. In this case, the aspherical shape is expressed by x=(h²/R)/[1+[1−(1+k)(h/R)²]^{1/2}]+A4h⁴+A6h⁶+A8h⁸+A10h¹⁰. Here, R is the radius of paraxial curvature. In addition, for example, the expression “E−Z” means “10^{-z}.”

The last two surfaces in each of the first through fourth numerical data are surfaces of an optical block, such as a filter or a face plate. In each of the numerical data, the back focus (BF) is the distance from the final lens surface to the paraxial image plane expressed in terms of the air-equivalent length. The total lens length is obtained by adding the back focus in the air-equivalent length to the distance from the lens surface closest to the object side to the final lens surface. In addition, the correspondence between the numerical data and the conditional expressions described above is shown in Table 1.

### First Numerical Data

unit: mm
surface data

| surface number | r | d | nd | νd |
|---|---|---|---|---|
| 1 | 162.346 | 0.30 | 2.00272 | 19.3 |
| 2 | 13.336 | 0.62 | | |
| 3 | ∞ | 5.50 | 2.00330 | 28.3 |
| 4 | ∞ | 0.07 | | |
| 5* | 7.833 | 1.23 | 1.80400 | 46.6 |
| 6* | −15.832 | (variable) | | |
| 7* | −10.074 | 0.30 | 1.88300 | 40.8 |
| 8* | 5.402 | 0.35 | | |
| 9 | −12.844 | 0.30 | 1.88300 | 40.8 |
| 10 | 4.753 | 0.72 | 1.95906 | 17.5 |
| 11 | 23.711 | (variable) | | |
| 12* | 4.694 | 0.85 | 1.49700 | 81.5 |
| 13 | −10.504 | 0.15 | | |
| 14 (aperture stop) | ∞ | (variable) | | |
| 15* | 10.880 | 2.15 | 1.69350 | 53.2 |
| 16 | −3.528 | 0.30 | 1.95906 | 17.5 |
| 17 | −6.093 | (variable) | | |
| 18 | 42.341 | 1.00 | 1.95906 | 17.5 |
| 19 | −8.351 | 0.12 | | |
| 20 | −11.994 | 0.30 | 2.00330 | 28.3 |
| 21* | 6.015 | (variable) | | |
| 22 | ∞ | 0.22 | 1.55671 | 58.6 |
| 23 | ∞ | 0.71 | | |
| image plane | ∞ | | | |

aspherical surface data
5th surface

| | | |
|---|---|---|
| K = 0.00000e+000 | A4 = −2.33880e−004 | A6 = 3.40372e−006 |

6th surface

| | | |
|---|---|---|
| K = 0.00000e+000 | A4 = 3.38653e−004 | A6 = 2.56696e−006 |

7th surface

| | |
|---|---|
| K = 0.00000e+000 | A4 = 1.41328e−003 |

8th surface

| | |
|---|---|
| K = 0.00000e+000 | A4 = −7.08145e−004 |

12th surface

| | | |
|---|---|---|
| K = 0.00000e+000 | A4 = −2.92059e−003 | A6 = 7.03522e−006 |

15th surface

| | | |
|---|---|---|
| K = 0.00000e+000 | A4 = −1.45127e−003 | A6 = −3.43261e−005 |

21st surface

| | | |
|---|---|---|
| K = 0.00000e+000 | A4 = 1.77456e−003 | A6 = 6.72980e−005 |
| A8 = −4.62797e−006 | | |

various pieces of data
zoom ratio 4.73

| | wide angle | intermediate | telephoto |
|---|---|---|---|
| focal length | 3.90 | 8.13 | 18.44 |
| F-number | 3.69 | 5.05 | 5.05 |
| half angle of view (degree) | 37.00 | 18.70 | 8.44 |
| image height | 2.60 | 2.86 | 2.86 |
| total lens length | 28.93 | 28.93 | 28.93 |
| BF | 2.85 | 6.09 | 9.33 |
| d6 | 0.37 | 2.55 | 4.74 |
| d11 | 3.37 | 1.75 | 0.20 |
| d14 | 6.08 | 2.90 | 0.09 |
| d17 | 1.98 | 1.36 | 0.30 |
| d21 | 2.00 | 5.24 | 8.48 |

zoom lens unit data

| unit | starting surface | focal length |
|---|---|---|
| 1 | 1 | 8.42 |
| 2 | 7 | −2.76 |
| 3 | 12 | 6.65 |
| 4 | 15 | 7.17 |
| 5 | 18 | −9.45 |
| 6 | 22 | ∞ |

### Second Numerical Data

unit: mm
surface data

| surface number | r | d | nd | νd |
|---|---|---|---|---|
| 1 | −9.491 | 0.30 | 2.00272 | 19.3 |
| 2 | −100.680 | 0.10 | | |
| 3 | ∞ | 4.00 | 2.00330 | 28.3 |
| 4 | ∞ | 0.07 | | |
| 5* | 5.321 | 1.37 | 1.80400 | 46.6 |
| 6* | −16.490 | (variable) | | |
| 7* | −8.616 | 0.30 | 1.88300 | 40.8 |
| 8* | 2.073 | 0.12 | | |
| 9 | 2.394 | 0.60 | 1.95906 | 17.5 |
| 10 | 3.878 | (variable) | | |
| 11* | 2.178 | 0.79 | 1.49700 | 81.5 |
| 12 | 52.972 | 0.20 | | |
| 13 (aperture stop) | ∞ | (variable) | | |
| 14* | 2.801 | 1.65 | 1.55332 | 71.7 |
| 15 | −1.867 | 0.30 | 2.00069 | 25.5 |
| 16 | −4.204 | (variable) | | |
| 17* | −3.135 | 0.30 | 1.80400 | 46.6 |
| 18* | 5.230 | 0.23 | | |
| 19 | 5.833 | 0.60 | 1.95906 | 17.5 |
| 20 | 22.665 | (variable) | | |
| 21 | ∞ | 0.22 | 1.55671 | 58.6 |
| 22 | ∞ | 0.34 | | |
| image plane | ∞ | | | |

aspherical surface data
5th surface

| | | |
|---|---|---|
| K = 0.00000e+000 | A4 = −1.45380e−003 | A6 = −1.78473e−006 |
| A8 = 4.42328e−006 | A10 = −1.50071e−006 | |

6th surface

| | | |
|---|---|---|
| K = 0.00000e+000 | A = −5.50269e−004 | A6 = 1.60307e−004 |
| A8 = −2.33680e−005 | A10 = 4.05611e−007 | |

7th surface

| | | |
|---|---|---|
| K = 0.00000e+000 | A4 = 7.44186e−003 | A6 = −1.21289e−003 |
| A8 = 1.72608e−004 | | |

8th surface

| | | |
|---|---|---|
| K = 0.00000e+000 | A4 = −1.95373e−003 | A6 = −1.01564e−003 |

11th surface

| | | |
|---|---|---|
| K = 0.00000e+000 | A4 = −1.10563e−002 | A6 = −1.13959e−003 |

14th surface

| | | |
|---|---|---|
| K = 0.00000e+000 | A4 = −4.41869e−003 | A6 = 1.36786e−003 |

17th surface

| | | |
|---|---|---|
| K = 0.00000e+000 | A4 = 1.35140e−002 | A6 = −7.06155e−003 |

18th surface

| | | |
|---|---|---|
| K = 0.00000e+000 | A4 = 1.91563e−002 | A6 = −4.40954e−003 |

various pieces of data
zoom ratio 2.84

| | wide angle | intermediate | telephoto |
|---|---|---|---|
| focal length | 3.90 | 7.23 | 11.07 |
| F-number | 3.69 | 4.90 | 5.05 |
| half angle of view (degree) | 37.90 | 21.70 | 13.90 |
| image height | 2.45 | 2.86 | 2.86 |
| total lens length | 17.95 | 17.95 | 17.95 |
| BF | 1.68 | 2.27 | 2.86 |
| d6 | 0.25 | 1.69 | 3.14 |
| d10 | 2.59 | 0.99 | 0.20 |
| d13 | 1.54 | 0.82 | 0.02 |
| d16 | 0.95 | 1.24 | 0.80 |
| d20 | 1.20 | 1.79 | 2.38 |

zoom lens unit data

| unit | starting surface | focal length |
|---|---|---|
| 1 | 1 | 6.87 |
| 2 | 7 | −2.65 |
| 3 | 11 | 4.55 |
| 4 | 14 | 5.10 |
| 5 | 17 | −3.57 |
| 6 | 21 | ∞ |

### Third Numerical Data

unit: mm
surface data

| surface number | r | d | nd | νd |
|---|---|---|---|---|
| 1 | −145.805 | 0.30 | 2.00272 | 19.3 |
| 2 | 15.160 | 0.62 | | |
| 3 | ∞ | 5.80 | 2.00330 | 28.3 |
| 4 | ∞ | 0.07 | | |
| 5* | 7.642 | 1.17 | 1.80400 | 46.6 |
| 6* | −16.517 | (variable) | | |
| 7* | −10.627 | 0.30 | 1.88300 | 40.8 |
| 8* | 5.735 | 0.34 | | |
| 9 | −130.158 | 0.30 | 1.88300 | 40.8 |
| 10 | 4.575 | 0.77 | 1.95906 | 17.5 |
| 11 | 16.181 | (variable) | | |
| 12* | 4.036 | 0.79 | 1.49700 | 81.5 |
| 13 | −80.156 | 0.15 | | |
| 14 (aperture stop) | ∞ | (variable) | | |
| 15* | 10.829 | 1.82 | 1.69350 | 53.2 |
| 16 | −3.403 | 0.30 | 1.95906 | 17.5 |
| 17 | −5.556 | (variable) | | |
| 18 | −1895.361 | 1.00 | 1.95906 | 17.5 |
| 19 | −7.006 | 0.12 | | |
| 20 | −8.140 | 0.30 | 2.00330 | 28.3 |
| 21* | 6.015 | (variable) | | |
| 22 | ∞ | 0.22 | 1.55671 | 58.6 |
| 23 | ∞ | 0.45 | | |
| image plane | ∞ | | | |

aspherical surface data
5th surface

| | | |
|---|---|---|
| K = 0.00000e+000 | A4 = −3.96594e−004 | A6 = 2.70051e−006 |

6th surface

| | | |
|---|---|---|
| K = 0.00000e+000 | A4 = 1.52352e−004 | A6 = 6.17604e−006 |

7th surface

| | |
|---|---|
| K = 0.00000e+000 | A4 = 8.32688e−004 |

8th surface

| | |
|---|---|
| K = 0.00000e+000 | A4 = −1.16068e−003 |

12th surface

| | | |
|---|---|---|
| K = 0.00000e+000 | A4 = −2.85079e−003 | A6 = −3.37490e−005 |

15th surface

| | | |
|---|---|---|
| K = 0.00000e+000 | A4 = −2.01279e−003 | A6 = −7.98692e−005 |

21st surface

| | | |
|---|---|---|
| K = 0.00000e+000 | A = 2.17720e−003 | A6 = 1.03262e−004 |
| A8 = −1.67458e−005 | | |

various pieces of data
zoom ratio 4.73

| | wide angle | intermediate | telephoto |
|---|---|---|---|
| focal length | 3.90 | 8.83 | 18.44 |
| F-number | 3.69 | 5.05 | 5.05 |
| half angle of view (degree) | 37.10 | 17.30 | 8.42 |
| image height | 2.60 | 2.86 | 2.86 |
| total lens length | 27.93 | 27.93 | 27.93 |
| BF | 2.59 | 5.48 | 8.38 |
| d6 | 0.37 | 2.58 | 4.80 |
| d11 | 4.17 | 1.94 | 0.20 |
| d14 | 4.48 | 2.17 | 0.09 |
| d17 | 2.15 | 1.60 | 0.31 |
| d21 | 2.00 | 4.89 | 7.79 |

zoom lens unit data

| unit | starting surface | focal length |
|---|---|---|
| 1 | 1 | 8.37 |
| 2 | 7 | −3.33 |
| 3 | 12 | 7.76 |
| 4 | 15 | 6.56 |
| 5 | 18 | −6.74 |
| 6 | 22 | ∞ |

### Fourth Numerical Data

unit: mm
surface data

| surface number | r | d | nd | νd |
|---|---|---|---|---|
| 1* | −11.500 | 0.30 | 2.00272 | 19.3 |
| 2 | −48.125 | 0.05 | | |
| 3 | ∞ | 4.20 | 2.00330 | 28.3 |
| 4 | ∞ | 0.07 | | |
| 5* | 5.200 | 1.34 | 1.80400 | 46.6 |
| 6* | −31.367 | (variable) | | |
| 7* | −5.248 | 0.30 | 1.88300 | 40.8 |
| 8* | 2.298 | 0.12 | | |
| 9 | 2.189 | 0.55 | 1.95906 | 17.5 |
| 10 | 3.131 | (variable) | | |
| 11* | 3.103 | 0.71 | 1.59522 | 67.7 |
| 12 | −10.051 | 0.20 | | |
| 13 (aperture stop) | ∞ | (variable) | | |
| 14* | 2.936 | 1.58 | 1.55332 | 71.7 |
| 15 | −2.508 | 0.30 | 1.95906 | 17.5 |
| 16 | −5.417 | (variable) | | |
| 17* | 14.601 | 0.30 | 1.69680 | 55.5 |
| 18 | 4.456 | 0.70 | | |
| 19* | −3.018 | 0.30 | 1.77250 | 49.6 |
| 20 | 14.843 | 0.05 | | |
| 21 | 7.937 | 0.81 | 1.95906 | 17.5 |
| 22 | −19.387 | (variable) | | |
| 23 | ∞ | 0.22 | 1.55671 | 58.6 |
| 24 | ∞ | 0.29 | | |
| image plane | ∞ | | | |

aspherical surface data
1st surface

| | | |
|---|---|---|
| K = 0.00000e+000 | A4 = −3.53518e−005 | A6 = 6.51847e−005 |
| A8 = −4.18130e−006 | A10 = 9.18762e−008 | |

5th surface

| | | |
|---|---|---|
| K = 0.00000e+000 | A4 = 1.11910e−003 | A6 = −1.64367e−004 |
| A8 = 7.84028e−006 | A10 = −1.17379e−006 | |

6th surface

| | | |
|---|---|---|
| K = 0.00000e+000 | A4 = 2.62576e−003 | A6 = −2.28888e−004 |

7th surface

| | | |
|---|---|---|
| K = 0.00000e+000 | A4 = 2.27542e−002 | A6 = −5.45092e−003 |
| A8 = 7.65211e−004 | | |

8th surface

| | | |
|---|---|---|
| K = 0.00000e+000 | A4 = 1.75543e−002 | A6 = −1.32942e−003 |

11th surface

| | | |
|---|---|---|
| K = 0.00000e+000 | A4 = −7.54808e−003 | A6 = 2.13196e−004 |

14th surface

| | | |
|---|---|---|
| K = 0.00000e+000 | A4 = −1.87930e−003 | A6 = 1.26597e−003 |

17th surface

| | | |
|---|---|---|
| K = 0.00000e+000 | A4 = 1.20446e−003 | A6 = −3.26771e−003 |

19th surface

| | | |
|---|---|---|
| K = 0.00000e+000 | A4 = −1.57617e−002 | A6 = −4.29495e−003 |

various pieces of data
zoom ratio 2.84

| | wide angle | intermediate | telephoto |
|---|---|---|---|
| focal length | 3.90 | 7.05 | 11.06 |
| F-number | 3.69 | 4.90 | 5.05 |
| half angle of view (degree) | 35.90 | 22.30 | 13.90 |
| image height | 2.45 | 2.86 | 2.86 |
| total lens length | 18.17 | 18.17 | 18.17 |
| BF | 1.23 | 2.04 | 2.84 |
| d6 | 0.25 | 1.65 | 3.06 |
| d10 | 2.18 | 0.88 | 0.19 |
| d13 | 2.30 | 1.10 | −0.00 |
| d16 | 0.33 | 0.61 | 0.20 |
| d22 | 0.80 | 1.61 | 2.41 |

zoom lens unit data

| unit | starting surface | focal length |
|---|---|---|
| 1 | 1 | 7.10 |
| 2 | 7 | −2.35 |
| 3 | 11 | 4.06 |
| 4 | 14 | 5.02 |
| 5 | 17 | −4.22 |
| 6 | 23 | ∞ |

TABLE 1

| | Conditional | | | |
|---|---|---|---|---|
| | Expressions | | | |
| | Conditional | Conditional | Conditional | Conditional |
| | Expression | Expression | Expression | Expression |
| Exemplary | (1) | (2) | (3) | (4) |
| Embodiments | M3/fw | f3/ft | f3/f5 | \|M5\|/fw |
| First | 0.31 | 0.36 | −0.70 | 1.63 |
| Exemplary | | | | |
| Embodiment | | | | |
| Second | 0.13 | 0.41 | −1.27 | 0.29 |
| Exemplary | | | | |
| Embodiment | | | | |
| Third | 0.11 | 0.42 | −1.15 | 1.46 |
| Exemplary | | | | |
| Embodiment | | | | |
| Fourth | 0.21 | 0.37 | −0.96 | 0.40 |
| Exemplary | | | | |
| Embodiment | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-242953, filed Dec. 14, 2015, which is hereby incorporated by reference herein in its entirety.

What is claimed is:

1. A zoom lens comprising:
a first lens unit having a positive refractive power;
a second lens unit having a negative refractive power;
a third lens unit having a positive refractive power;
a fourth lens unit having a positive refractive power; and
a fifth lens unit having a negative refractive power, the first through fifth lens units being disposed in order from an object side to an image side,
wherein, when zooming, a distance between adjacent lens units changes,
wherein the first lens unit includes a reflective member having a reflective surface configured to bend an optical path,
wherein the third lens unit includes an aperture stop, and
wherein, when zooming, the third lens unit moves such that the third lens unit is located closer to the image side at a telephoto end than at a wide angle end.

2. The zoom lens according to claim 1,
wherein the following conditional expression is satisfied
0.05<M3/fw<0.80,
wherein M3 represents an amount of movement of the third lens unit when zooming from the wide angle end to the telephoto end, and fw represents a focal length of an entire system at the wide angle end.

3. The zoom lens according to claim 1,
wherein when zooming from the wide angle end to the telephoto end,
the first lens unit is stationary,
the second lens unit moves toward the image side, and
the fourth lens unit and the fifth lens unit move toward the object side.

4. The zoom lens according to claim 1,
wherein the following conditional expression is satisfied
0.2<f3/ft<0.7,
wherein f3 represents a focal length of the third lens unit, and ft represents a focal length of an entire system at the telephoto end.

5. The zoom lens according to claim 1,
wherein the following conditional expression is satisfied
−1.4<f3/f5<−0.4,
wherein f3 represents a focal length of the third lens unit, and f5 represents a focal length of the fifth lens unit.

6. The zoom lens according to claim 1,
wherein the following conditional expression is satisfied
0.2<|M5|/fw<3.0,
wherein M5 represents an amount of movement of the fifth lens unit when zooming from the wide angle end to the telephoto end, and fw represents a focal length of an entire system at the wide angle end.

7. The zoom lens according to claim 1,
wherein the fifth lens unit moves toward the image side when focusing from infinity to close range.

8. The zoom lens according to claim 1,
wherein when zooming from the wide angle end to the telephoto end, the third lens unit moves monotonically toward the image side or moves toward the image side and then moves toward the object side.

9. The zoom lens according to claim 1,
wherein the first lens unit is constituted by a negative lens, the reflective member including the reflective surface configured to bend the optical path, and a positive lens that are disposed in order from the object side toward the image side.

10. The zoom lens according to claim 9,
wherein the reflective member includes a prism or a mirror disposed between the negative lens and the positive lens, and
wherein the prism or the mirror is configured to bend the optical path of light traveling between the negative lens and the positive lens of the first lens unit.

11. The zoom lens according to claim 1,
wherein the third lens unit is constituted by a positive lens, and
wherein the aperture stop is disposed on the image side of the positive lens.

12. An image pickup apparatus, comprising:
the zoom lens according to claim 1; and
a solid-state image pickup element configured to receive an image formed by the zoom lens.
